(19) United States
(12) Patent Application Publication
(10) Pub. No.: US 2024/0105398 A1
(43) Pub. Date: Mar. 28, 2024

(54) ALIGNMENT DEVICE AND METHOD OF FORMING EXTERNAL ELECTRODE

(71) Applicant: Murata Manufacturing Co., Ltd., Nagaokakyo-shi (JP)

(72) Inventor: Yasuhiro SHIMIZU, Nagaokakyo-shi (JP)

(21) Appl. No.: 18/533,265

(22) Filed: Dec. 8, 2023

Related U.S. Application Data
(63) Continuation of application No. PCT/JP2022/012292, filed on Mar. 17, 2022.

(30) Foreign Application Priority Data
Jun. 17, 2021 (JP) 2021-101121

(51) Int. Cl. H01G 13/00; H01G 4/012

(52) U.S. Cl. CPC H01G 13/00; H01G 4/012; H01G 4/30

(57) ABSTRACT

An alignment device includes a pallet including a flat plate portion and a lateral wall portion defining an alignment area to which chips are supplied, recessed portions defining holding positions in the alignment area to hold the chips in an alignment state, a supply port defined by a portion of the lateral wall portion being open and allowing the chips to be supplied into the alignment area from outside of the lateral wall portion, and a magnet defining a moving holder at least at either one of the flat plate portion or the lateral wall portion to cause each of the chips supplied from the supply port to the alignment area to move to a corresponding one of the recessed portions and hold each of the chips at a corresponding one of the recessed portions.

### CROSS REFERENCE TO RELATED APPLICATIONS

This application claims the benefit of priority to Japanese Patent Application No. 2021-101121 filed on Jun. 17, 2021 and is a Continuation Application of PCT Application No. PCT/JP2022/012292 filed on Mar. 17, 2022. The entire contents of each application are hereby incorporated herein by reference.

### BACKGROUND OF THE INVENTION

### 1. Field of the Invention

The present invention relates to alignment devices to align a plurality of workpieces such as chip components, and methods of forming external electrodes on the workpieces.

### 2. Description of the Related Art

Conventionally, for chip-shaped electronic components such as semiconductor devices or multilayer ceramic capacitors, a plurality of components in a manufacturing process or a plurality of components after manufacturing are sometimes aligned in a fixed direction from a loose state using an alignment device. For example, Japanese Unexamined Patent Application Publication No. 2004-75519 discloses a setting jig serving as such an alignment device including a plurality of recessed portions opened upward, each functioning as a holder and allowing the plurality of recessed portions to accommodate workpieces therein one by one such that the plurality of workpieces are aligned.

### SUMMARY OF THE INVENTION

In a conventional alignment device such as the abovementioned setting jig, it is difficult to obtain a state in which the workpieces are accommodated in all the recessed portions, and the filling rate of the recessed portions is low. In addition, there are some cases where the workpieces are difficult to be securely held in the recessed portions, and as a result, the posture of each of the workpieces in the recessed portion becomes unstable, or the workpieces are ejected out of the recessed portions due to vibration.

Accordingly, example embodiments of the present invention provide alignment devices each capable of accurately holding a plurality of workpieces at each of a plurality of holding positions set in advance and obtaining a sufficient filling rate as a result.

An example embodiment of the present application provides an alignment device including a pallet including a flat plate portion including a surface and a rear surface, and a lateral wall portion that extends from the surface of the flat plate portion and includes an alignment area to which a plurality of workpieces are supplied, the pallet being configured to be vibrated, a plurality of holding positions in the alignment area each to hold a corresponding one of the plurality of workpieces in an alignment state, a supply port including a portion of the lateral wall portion of the pallet and being open to allow the plurality of workpieces to be supplied into the alignment area from outside of the lateral wall portion, and a moving holder provided in the flat plate portion to cause each of the plurality of workpieces supplied from the supply port to the alignment area to move to a corresponding one of the plurality of holding positions, and hold each of the plurality of workpieces at a corresponding one of the plurality of holding positions.

According to example embodiments of the present invention, it is possible to provide alignment devices each capable of accurately holding a plurality of workpieces at each of a plurality of holding positions set in advance, and obtaining a sufficient filling rate as a result.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a schematic plan view of an alignment device and a linear feeder connected to an alignment device according to a first example embodiment of the present invention.

FIG. 2 is a perspective view of a chip serving as a workpiece according to the first example embodiment of the present invention.

FIG. 3 is a perspective view of a pallet included in the alignment device according to the first example embodiment of the present invention.

FIG. 4 is a plan view of a pallet included in the alignment device according to the first example embodiment of the present invention.

FIG. 5 is a schematic view of a configuration of an alignment device including a cross-sectional view taken along the line V-V of FIG. 4.

FIG. 6 is an enlarged cross-sectional view of a state in which a chip is accommodated in a recessed portion of the pallet according to the first example embodiment of the present invention.

FIG. 7 is a view taken in the direction of arrow VII in FIG. 6.

FIG. 8 is a flowchart of a method of forming an external electrode according to an example embodiment of the present invention in step order.

FIGS. 9A to 91 are transition diagrams of the movement of the chip in the order of 9A to 9I according to the steps of the method of forming an external electrode according to an example embodiment of the present invention.

FIG. 10 is a plan view of an alignment device according to a second example embodiment of the present invention.

FIG. 11 is a cross-sectional view of the alignment device according to the second example embodiment of the present invention.

FIG. 12 is a cross-sectional view of an alignment device according to a third example embodiment of the present invention.

FIG. 13 is a cross-sectional view of an alignment device according to a fourth example embodiment of the present invention.

FIG. 14 is a cross-sectional view of an alignment device according to a fifth example embodiment of the present invention.

FIG. 15 is a plan view of an alignment device according to a sixth example embodiment of the present invention.

FIG. 16 is a cross-sectional view of an alignment device according to a seventh example embodiment of the present invention.

FIG. 17 is a cross-sectional view of a modified example of the alignment device according to the seventh example embodiment of the present invention.

FIG. 18 is a plan view of an alignment device according to an eighth example embodiment of the present invention.

FIG. 19 is a cross-sectional view of the alignment device according to the eighth example embodiment of the present invention.

FIG. 20 is a plan view of an alignment device according to a modified example of the eighth example embodiment of the present invention.

### DETAILED DESCRIPTION OF THE EXAMPLE EMBODIMENTS

Hereinafter, example embodiments of the present invention will be described.

### Alignment Device

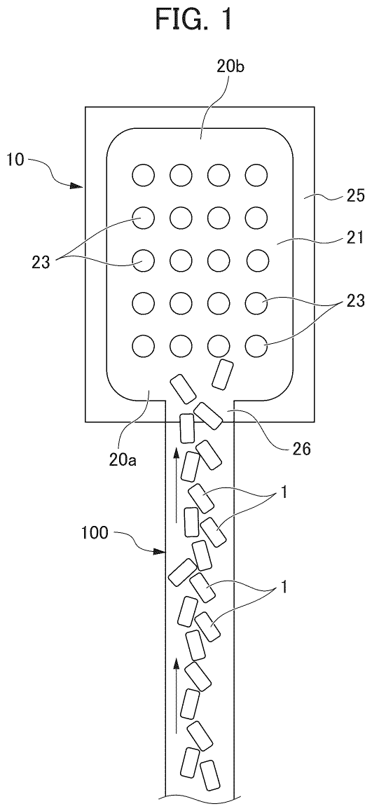

FIG. 1 is a plan view of an alignment device 10 according to a first example embodiment and a linear feeder 100 connected to the alignment device 10. A plurality of chips 1 are supplied from the linear feeder 100 to the alignment device 10. Each of the chips 1 is an example of a workpiece.

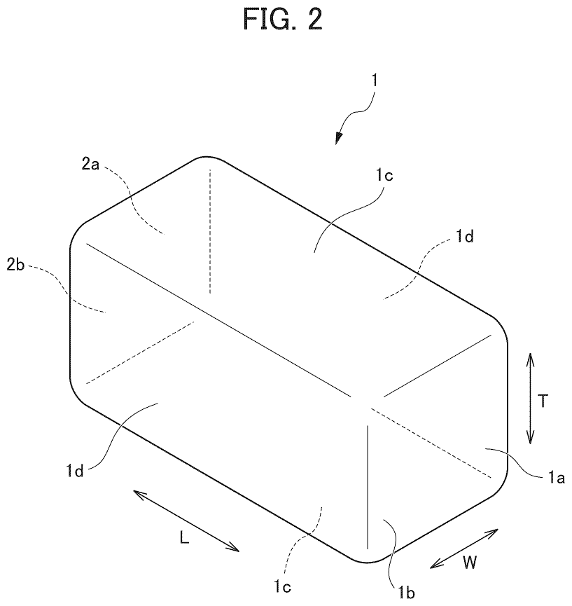

As shown in FIG. 2, the chip 1 according to the example embodiment is a rectangular or substantially rectangular parallelepiped microelectronic component having a length direction L, a width direction W orthogonal or substantially orthogonal to the length direction L, and a thickness direction T orthogonal or substantially orthogonal to the length direction L and the width direction W. The chip 1 includes a first end surface 1a and a second end surface 2a at both ends in the length direction. Here, one end portion in the length direction adjacent to the first end surface 1a is referred to as an end portion 1b on the first end surface, and the other end portion in the length direction adjacent to the second end surface 2a is referred to as an end portion 2b on the second end surface. The chip 1 includes a pair of main surfaces 1c opposed to each other in the thickness direction T and a pair of lateral surfaces 1d opposed to each other in the width direction W.

The chip 1 of the present example embodiment is a laminate body in a multilayer ceramic capacitor before an external electrode is formed at each of the end portion 1b on the first end surface and the end portion 2b on the second end surface. The laminate body is a multilayer structure in which internal electrode layers and dielectric ceramic layers are alternately laminated. As the chip 1 of the present example embodiment, a laminate body is provided such that the internal electrode layers include Ni or the like, and thus the laminate body has a magnetic property.

The alignment device 10 according to the present example embodiment is a device in which the plurality of chips 1 supplied from the linear feeder 100 are aligned in a state in which their longitudinal directions are aligned in the same direction and arranged in a matrix.

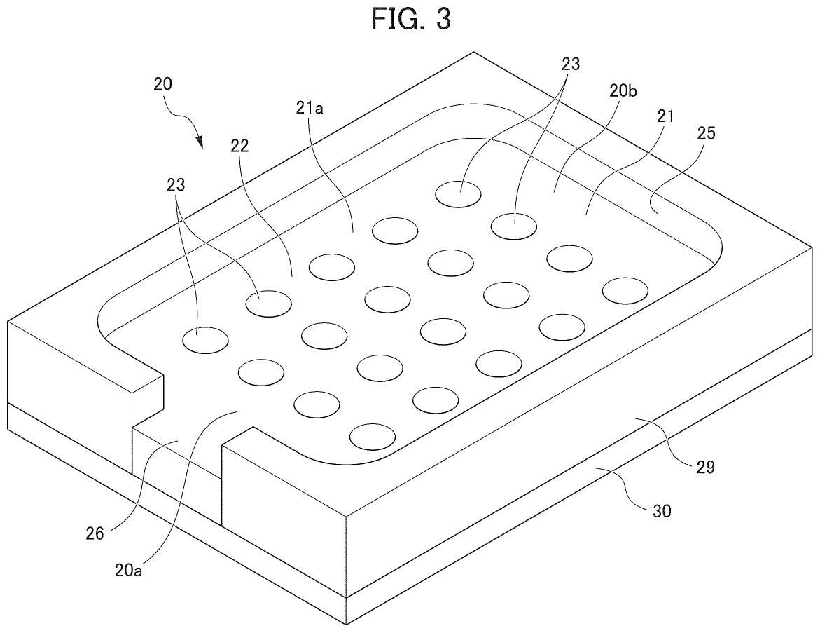

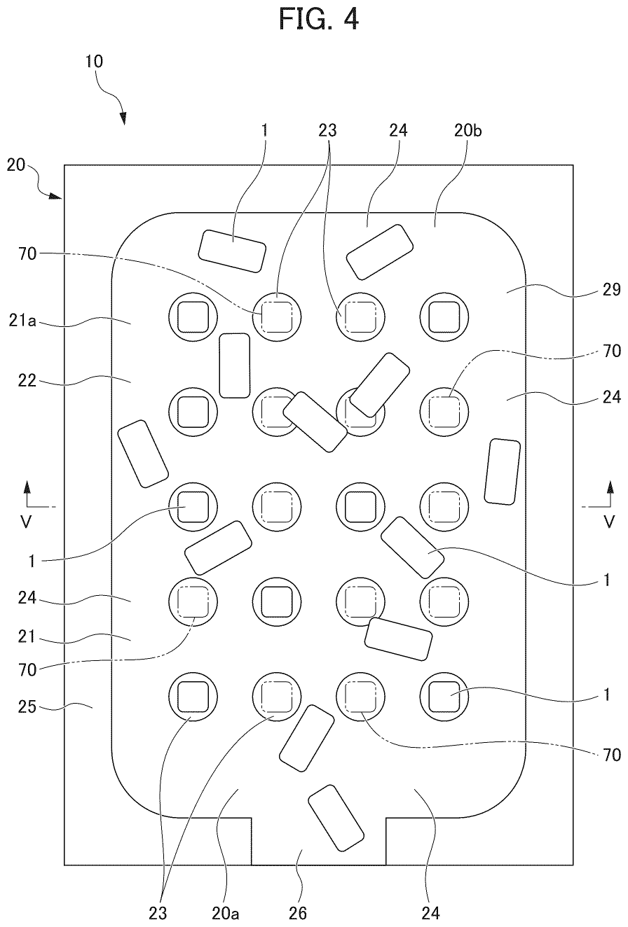

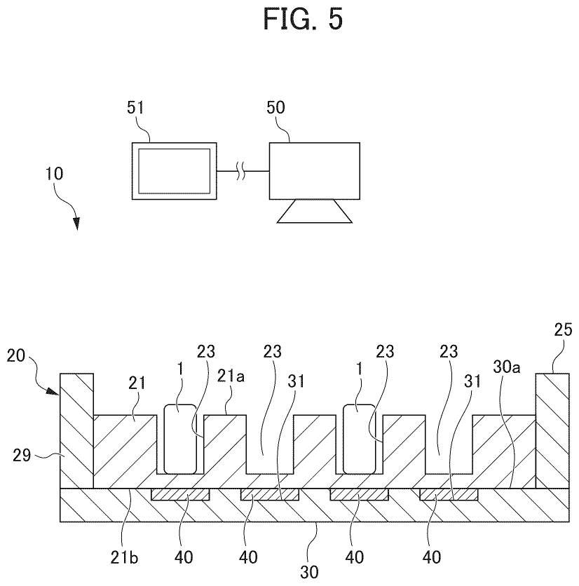

FIG. 3 is a perspective view of a pallet 20 included in the alignment device 10. FIG. 4 is a plan view of the pallet 20. FIG. 5 is a view schematically showing a configuration of the alignment device 10 including a cross-sectional view taken along the line V-V of FIG. 4. As shown in FIG. 5, the alignment device 10 includes a pallet 20, a plurality of first magnets 40, and an imaging unit 50. The first magnet 40 is an example of a moving holder.

The pallet 20 includes a pallet body 29 and a base 30. The pallet body 29 includes a flat plate portion 21 and a lateral wall portion 25 provided at a peripheral edge of the flat plate portion 21. The flat plate portion 21 is a rectangular or substantially rectangular plate-shaped member having a surface 21a and a rear surface 21b. The pallet body 29 is provided such that the surface 21a faces upward and is substantially horizontal. The lateral wall portion 25 rises from the surface 21a of the flat plate portion 21, and surrounds the flat plate portion 21. The surface 21a of the flat plate portion 21 surrounded by the lateral wall portion 25 is partitioned and defined as an alignment area 22 to which the plurality of chips 1 are supplied. The flat plate portion 21 and the lateral wall portion 25 may be separate or integrated. Further, the lateral wall portion 25 may be provided inside the peripheral edge of the flat plate portion 21 instead of the peripheral edge of the flat plate portion 21.

As shown in FIG. 4, the pallet 20 of the example embodiment has a rectangular or substantially rectangular shape in a plan view. At the center of the short side portion of one side (the lower side in FIG. 4) of the pallet 20, a supply port 26 that allows the plurality of chips 1 to be supplied to the alignment area 22 is provided. The supply port 26 is provided by cutting out and opening a portion of the lateral wall portion 25 in the circumferential direction. The distal end of the linear feeder 100 shown in FIG. 1 is provided in the supply port 26. The plurality of chips 1 are supplied from the linear feeder 100 through the supply ports 26 to the alignment area 22. The supply port 26 is an inlet through which the plurality of chips 1 are supplied from the outside of the lateral wall portion 25 to the alignment area 22.

A plurality of holding positions 70 are set in the alignment area 22. Each of the holding positions 70 is a position at which the chip 1 is held. In FIG. 4, each of the holding positions 70 has a shape corresponding to a cross section (the WT cross section) of the chip 1 along the width direction W and the height direction T assuming that the chip 1 is vertically placed. In the first example embodiment, each of the plurality of holding positions 70 includes a recessed portion 23.

As shown in FIG. 4, in the alignment area 22, a surplus portion 24 in which the recessed portion 23 is not provided is provided between the lateral wall portion 25 and the plurality of recessed portions 23 provided on the outermost peripheral side.

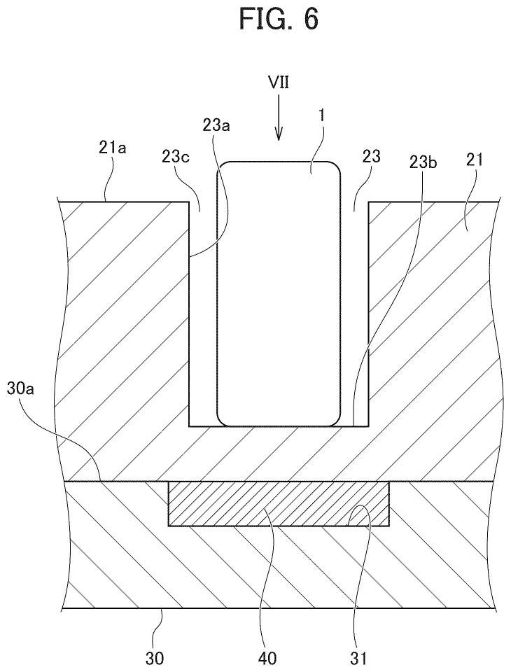

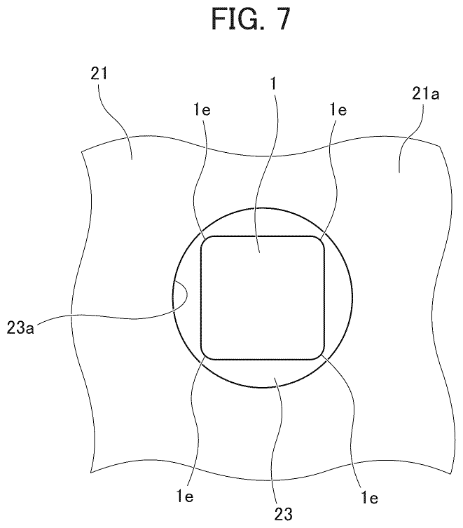

As shown in FIGS. 6 and 7, the recessed portion 23 is a recess surrounded by a cylindrical inner wall surface 23a and a bottom surface 23b, and has an opening 23c opened to the surface 21a. The axial direction of the inner wall surface 23a is orthogonal or substantially orthogonal to the surface 21a. As shown in FIG. 4, the plurality of recessed portions 23 of the example embodiment, i.e., twenty of the recessed portions 23 are provided in a matrix of 4 rows×5 columns. The intervals between the adjacent recessed portions 23 are equal or substantially equal, and the plurality of chips 1 are evenly provided. The number and arrangement of the recessed portions 23 in the present example embodiment are only examples, and example embodiments of the present invention are not limited thereto.

The diameter of the recessed portion 23 is slightly larger than the length of the diagonal line of the first end surface 1a and the second end surface 2a of the chip 1. The depth of the recessed portion 23 is slightly shorter than the length of the chip 1 (the dimension in the length direction L). One chip 1 can be accommodated in the recessed portion 23 in a vertical posture with the length direction of the chip 1 following the vertical direction. The chip 1 passes through the opening 23c from the end portion 1b on the first end surface or the end portion 2b on the second end surface, and enters the recessed portion 23 along the inner wall surface 23a, and is accommodated in the vertical posture. As shown in FIG. 7, the four corner portions 1e extending in the length direction of the chip 1 are brought adjacent to or in contact with the inner wall surface 23a, such that the chip 1 is held in a vertically nested posture. Since the depth of the recessed portion 23 is slightly shorter than the length of the chip 1, as shown in FIG. 6, the end portion in the length direction of the chip 1 protrudes from the opening 23c to a certain length above the surface 21a.

Each of the plurality of chips 1 supplied from the supply port 26 to the alignment area 22 moves from the front-side end portion 20a, which is the end portion on the supply port 26 side of the pallet 20, toward the rear-side end portion 20b on the opposite side of the supply port 26, and is accommodated in the recessed portion 23 in the middle of the movement.

The base 30 is a plate-shaped member having dimensions equal or substantially equal to those of the pallet body 29 in a plan view. The pallet body 29 is provided on the upper surface 30a of the base 30. It is preferable that the pallet body 29 is detachably fixed to the base 30.

As shown in FIG. 5, the upper surface 30a of the base 30 includes a plurality of magnet accommodation portions 31 corresponding to the respective recessed portions 23 provided at the plurality of holding positions 70 of the pallet 20. The magnet accommodation portions 31 are recessed portions opened on the upper surface 30a, and are provided immediately below the respective recessed portions 23. The plurality of magnet accommodation portions 31 each include a corresponding first magnet 40 fitted and accommodated therein. The plurality of first magnets 40 are provided on the rear surface 21b of the flat plate portion 21 of the pallet body 29 so that the first magnets 40 respectively correspond to the plurality of recessed portions 23. Each of the first magnets 40 of the first example embodiment is an electromagnet in which the magnetic force is turned on/off by turning on/off the energization. It is preferable that the plurality of first magnets 40 are individually turned on/off.

The linear feeder 100 shown in FIG. 1 is installed to extend horizontally or substantially horizontally toward the alignment device 10. The distal end of the linear feeder 100 is provided in the supply port 26 of the alignment device 10. The plurality of chips 1 are supplied onto the linear feeder 100, and the linear feeder 100 vibrates under a predetermined condition, such that the plurality of chips 1 are continuously conveyed toward the alignment device 10. The plurality of chips 1 are conveyed while being pushed by the subsequent chips 1 one by one or in a state of the plurality of chips 1 being bundled, and are supplied from the supply port 26 to the alignment device 10 in a loose state. In the alignment device 10, vibration is applied to the pallet 20 by a vibration source (not shown). The chips 1 move from the front-side end portion 20a to the rear-side end portion 20b by the vibrating pallet 20. The rectangular or substantially rectangular parallelepiped chips 1 are likely to move in a horizontal posture in which the main surface 1c or the lateral surface 1d is in contact with the surface 21a.

A vibration may not be applied directly to the pallet 20. Alternatively, the vibration of the linear feeder 100 coupled to the pallet 20 may be transmitted to the pallet 20 to vibrate the pallet 20, thus moving the chips 1 in the pallet 20. That is, the vibration of the linear feeder 100 connected to the supply port 26 of the pallet 20 may be transmitted to the pallet 20 to apply vibration common to the linear feeder 100 to the pallet 20. With such a configuration, since it is possible to share the vibration source of the linear feeder 100 with the pallet 20, it is possible to simplify the configuration.

In the first example embodiment, as shown in FIG. 5, the imaging unit 50 is provided above the pallet 20. The imaging unit 50 includes a camera capable of imaging the entire alignment area 22. An image captured by the imaging unit 50 is displayed on the monitor 51. By observing the monitor 51, it is possible to understand a state in which the chips 1 are accommodated in the recessed portion 23.

According to the alignment device 10 of the first example embodiment having the above-described configuration, the plurality of chips 1 supplied from the linear feeder 100 to the alignment area 22 in a loose state are moved to the respective recessed portions 23 by the attractive force of the first magnet 40 which is energized and whose magnetic force is turned on, and are accommodated in the recessed portions 23 one by one in the vertical posture. As described above, since each of the chips 1 is a laminate body of a multilayer ceramic capacitor in which internal electrode layers including Ni or the like are laminated, each of the chips 1 has a magnetic property. Therefore, the chip 1 can be attracted to the first magnet 40.

When all the recessed portions 23 respectively accommodate the chips 1 therein, the plurality of chips 1 are aligned in a state of 4 rows×5 columns corresponding to the recessed portions 23. Understanding the state of accommodation of the chips 1 in the recessed portions 23 while looking at the monitor 51, it may also be configured to turn off the energization of the first magnets 40 corresponding to the recessed portions 23 in which the chips 1 are accommodated, i.e., the first magnets 40 immediately below the recessed portions 23, and keep energizing the other first magnets 40 corresponding to the recessed portions 23 until the chips 1 are accommodated.

According to the alignment device 10 of the first example embodiment, each of the plurality of chips 1 supplied from the feeder 100 to the alignment area 22 of the pallet 20 moves from the front-side end portion 20a to the rear-side end portion 20b by the vibration of the pallet 20, and during the movement, the chips 1 are attracted by the first magnets 40 and accommodated in the recessed portions 23 one by one and held in the recessed portions 23. With such a configuration, it is possible to accurately hold each of the plurality of chips 1 in the corresponding recessed portion 23 provided in each of the plurality of holding positions 70 set in advance. Since the chip 1 is held in a state of being accommodated in the recessed portion 23 by being attracted by the first magnet 40, even if the pallet 20 vibrates, it is possible to reduce or prevent a situation in which the chip 1 jumps out from the recessed portion 23. Therefore, since the chips 1 are likely to be filled in all of the plurality of recessed portions 23, it is possible to obtain a sufficient filling rate.

### External Electrode Forming Method

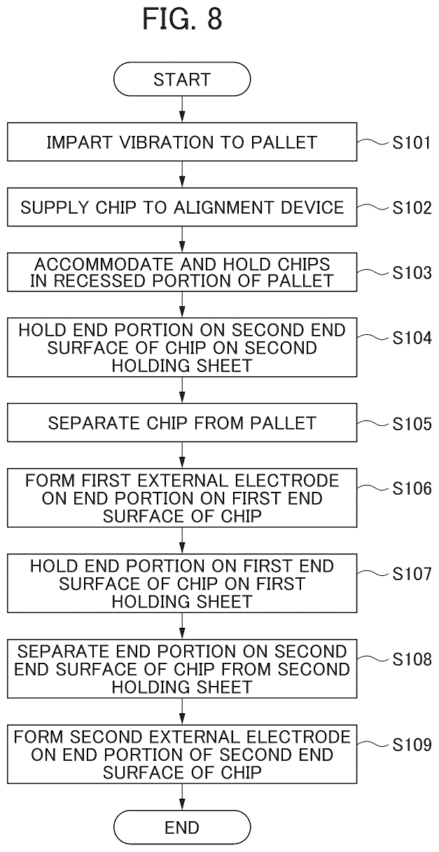

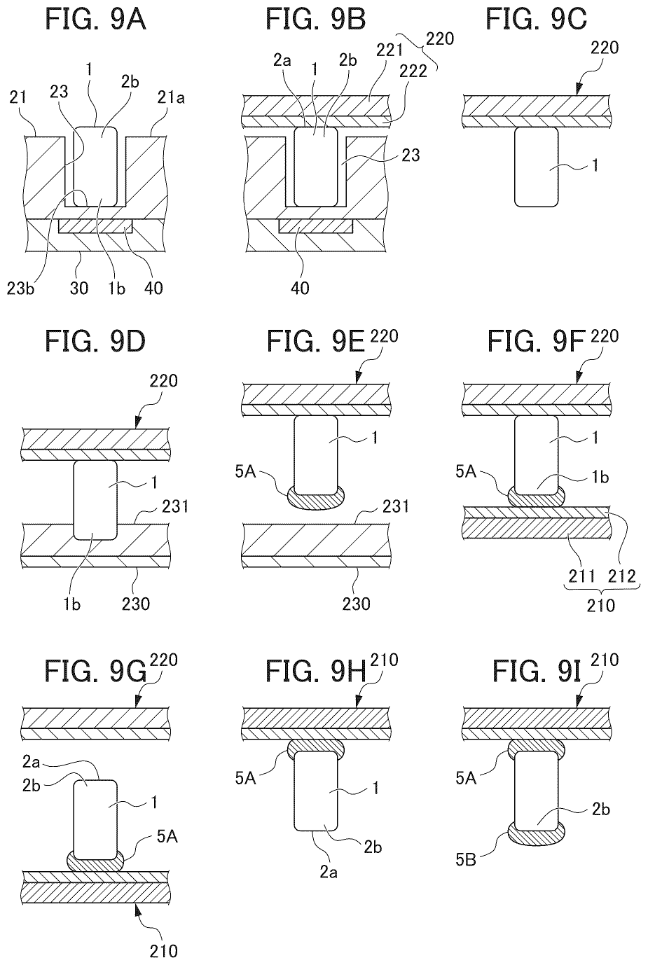

Next, with reference to FIGS. 8, and 9A to 9I, a non-limiting example of a method of forming an external electrode on each of the end portion 1b on the first end surface and the end portion 2b on the second end surface of each of the plurality of chips 1 using the alignment device 10 of the first example embodiment will be described.

FIG. 8 is a flowchart of a method of forming an external electrode according to the present example embodiment in order of steps. FIGS. 9A to 9I are each a transition diagram of the movement of the chip 1 according to the steps in the order of 9A to 9I. For convenience of explanation, FIGS. 9A to 9I shows one chip 1 solely. However, in practice, all the chips 1 accommodated in the plurality of recessed portions 23 are processed collectively in the same manner.

First, vibration is applied to the pallet 20 of the alignment device 10 (step S101). Next, the linear feeder 100 conveys the plurality of chips 1 toward the alignment device 10, and supplies the plurality of chips 1 from the supply port 26 to the alignment area 22 of the pallet 20 (step S102). Each of the plurality of chips 1 is attracted by the first magnet 40 and moved to the recessed portion 23, and as shown in FIG. 9A, each of the plurality of chips 1 is accommodated in the recessed portion 23 from one end portion in the length direction in a vertical posture and held therein (step S103). Here, the end portion that comes into the recessed portion 23 and comes into contact with the bottom surface 23b is referred to as the end portion 1b on the first end surface, and the other end portion that protrudes from the opening 23c of the recessed portion 23 toward the surface 21a of the flat plate portion 21 and is separated from the surface 21a is referred to as the end portion 2b on the second end surface. That is, in step S103, the end portion 1b on the first end surface of the chip 1 is held in the recessed portion 23, and the end portion 2b on the second end surface is held in a state of being separated from the surface 21a of the pallet 20.

Next, as shown in FIG. 9B, the end portions 2b on the second end surface of the plurality of chips 1 held in the plurality of recessed portions 23 are collectively held by a second holding sheet 220 (step S104). The second holding sheet 220 includes a base material 221 and an adhesive layer 222 provided on one surface of the base material 221. The second end surface 2a of each chip 1 is pressed against the adhesive layer 222 of the second holding sheet 220, such that the end portion 2b on the second end surface is adhesively held on the second holding sheet 220.

Next, as shown in FIG. 9C, the plurality of chips 1 held by the second holding sheet 220 are collectively separated from the recessed portions 23 (step S105). Next, first external electrodes 5A each defining and functioning as an external electrode are collectively formed on the end portions 1b on the first end surface exposed in the plurality of chips 1 held by the second holding sheet 220 (step S106). In step S106, as shown in FIG. 9D, the end portions 1b on the first end surface of the plurality of chips 1 held by the second holding sheet 220 are immersed in a conductive paste 231 held on the plate 230, and then, as shown in FIG. 9E, the plurality of chips 1 are collectively separated from the conductive paste 231 together with the second holding sheet 220. With such a configuration, the conductive paste 231 adheres to the end portions 1b on the first end surface of the plurality of chips 1. By drying the conductive paste 231, the first external electrodes 5A are formed at the end portions 1b on the first end surface.

Next, as shown in FIG. 9F, with regard to the plurality of chips 1 held by the second holding sheet 220, each of the end portions 1b on the first end surface on which the first external electrodes 5A is formed is held by a first holding sheet 210 (step S107). The first holding sheet 210 includes a base material 211 and an adhesive layer 212 provided on one surface of the base material 211. The first external electrodes 5A of the chips 1 are pressed against the adhesive layer 212 of the first holding sheet 210, such that the end portions 1b on the first end surface are adhesively held on the first holding sheet 210.

Next, the end portions 2b on the second end surface of the plurality of chips 1 held by the second holding sheet 220 are peeled off and separated from the second holding sheet 220 (step S108). That is, as shown in FIG. 9G, the second end surface 2a of each chip 1 is separated from the second holding sheet 220. For example, when the adhesive force of the adhesive layer 222 of the second holding sheet 220 is weaker than that of the adhesive layer 212 of the first holding sheet 210, the second holding sheet 220 can be easily peeled off from the chips 1, while holding the chips 1 on the first holding sheet 210.

Next, with regard to the plurality of chips 1 held by the first holding sheet 210, second external electrodes 5B each defining and functioning as an external electrode are collectively formed on the end portions 2b on the second end surface separated from the second holding sheet 220 (step S109). In step S109, as shown in FIG. 9H, the first holding sheet 210 is inverted to provide the second end surfaces 2a of the chips 1 on the lower side. Next, in the same manner as in FIG. 9D, the end portions 2b on the second end surface of the plurality of chips 1 are immersed in the conductive paste 231, and then pulled up from the conductive paste 231, such that the conductive paste 231 is attached to the end portions 2b on the second end surface of the plurality of chips 1. By drying the conductive paste 231, the second external electrodes 5B are formed on the end portions 2b on the second end surface as shown in FIG. 9I.

In addition, the external electrode 5A and the external electrode 5B may include a single layer structure including the conductive paste 231 as described above, or may include a multilayer structure further including a plated layer on its surface.

According to the method of forming the external electrode described above, the first external electrode 5A and the second external electrode 5B are collectively formed on the plurality of chips 1 while holding the plurality of chips 1 aligned in the alignment device 10 on the first holding sheet 210 and the second holding sheet 220, respectively. Therefore, it is possible to efficiently form the first external electrode 5A and the second external electrode 5B.

According to the example embodiment described above, it is possible to achieve the following advantageous effects. The alignment device 10 according to the present example embodiment includes the pallet 20 including the flat plate portion 21 including the surface 21a and the rear surface 21b, and the lateral wall portion 25 that rises on the surface 21a of the flat plate portion 21 and defines the surface 21a inside the lateral wall portion 25 as the alignment area 22 to which a plurality of chips 1 are supplied, the pallet 20 being configured to be vibrated, the plurality of holding positions 70 set in the alignment area 22 in which each of the plurality of chips 1 supplied in the alignment area 22 is positioned in a corresponding one of the plurality of holding positions 70, thus holding an alignment state of the plurality of chips 1, the supply port 26 that is provided by a portion of the lateral wall portion 25 of the pallet 20 being open and allows the plurality of chips 1 to be supplied into the alignment area 22 from outside of the lateral wall portion 25, and the first magnet 40 defining and functioning as the moving holder provided in the flat plate portion 21, the moving holder being configured to cause each of the plurality of chips 1 supplied from the supply port 26 to the alignment area 22 to move to a corresponding one of the plurality of holding positions 70, and hold each of the plurality of chips 1 at a corresponding one of the plurality of holding positions 70.

With such a configuration, it is possible to accurately hold and align the plurality of chips 1 respectively at the plurality of holding positions 70 set in advance, and it is possible to obtain a sufficient filling rate.

Since the supply port 26 is provided in the lateral wall portion 25 of the pallet 20, it is possible to supply the chips 1 from the supply port 26 into the pallet 20 in a state of being moved horizontally or substantially horizontally. The chips 1 are thus hardly damaged by an impact applied to the chips 1.

The alignment device 10 according to the present example embodiment further includes the recessed portion 23 that accommodates the chip 1 at each of the plurality of holding positions 70.

Since the movement of the chips 1 accommodated in the recessed portion 23 in the plane direction of the surface 21a of the pallet 20 is regulated and thus the chips 1 hardly moves, it is possible to securely hold the chips 1 at the holding positions 70 and it is possible to position and align the chips 1 at the holding positions 70 with high accuracy.

In the alignment device 10 according to the present example embodiment, the moving holder is the first magnet 40 that moves the chips 1 to one of the holding positions 70 by magnetic attractive force and holds the chips 1 at the holding positions 70.

With such a configuration, it is possible to accurately hold the plurality of chips 1 by the magnetic force at the plurality of holding positions 70 set in advance. Since each of the chips 1 is held in a state of being accommodated in the recessed portion 23 at the holding position 70 by being attracted by the first magnet 40, even if the pallet 20 vibrates, a situation in which the chip 1 jumps out from the recessed portion 23 can be reduced or prevented. Therefore, since the chips 1 are filled and held in all of the plurality of recessed portions 23, it is possible to obtain a sufficient filling rate.

In the alignment device 10 according to the present example embodiment, the first magnets 40 are provided on the rear surface 21b of the flat plate portion 21 of the pallet 20 in a manner respectively corresponding to the plurality of holding positions 70.

Since the first magnets 40 are provided at all the holding positions 70, it is possible to securely hold the chips 1 at the holding positions 70 by the first magnets 40, and it is possible to obtain a sufficient filling rate.

The alignment device 10 according to the present example embodiment preferably includes the linear feeder 100 which is connected to the supply port 26 of the pallet 20 and conveys the chips 1 to the alignment area 22 of the pallet 20 by vibration, and vibration of the linear feeder 100 is transmitted to the pallet 20 to apply vibration common to the linear feeder 100. With such a configuration, since the vibration source of the linear feeder 100 can be shared with the pallet 20, it is possible to simplify the configuration.

The method of forming an external electrode on each of the end portion 1b on the first end surface and the end portion 2b on the second end surface included in each of the plurality of chips 1 using the above-described alignment device 10 according to the present example embodiment includes giving vibration to the pallet 20 (step S101), supplying the plurality of chips 1 from the supply port 26 to the alignment area 22 (step S102), the first magnet 40 defining and functioning as a moving holder causing each of the plurality of chips 1 supplied to the alignment area 22 to move to a corresponding one of the plurality of holding positions 70, holding the end portion 1b on the first end surface of each of the plurality of chips 1 at a corresponding one of the plurality of holding positions 70, and holding the end portion 2b on the second end surface in a state of being separated from the surface 21a of the flat plate portion 21 (step S103), holding collectively the end portion 2b on the second end surface of the plurality of chips 1 respectively held at the plurality of holding positions 70 on the second holding sheet 220 (step S104), separating collectively the plurality of chips held on the second holding sheet 220 from the respective holding positions 70 (step S105), forming collectively the first external electrode 5A defining and functioning as the external electrode on the end portion 1b on the first end surface of each of the plurality of chips 1 held on the second holding sheet 220 (step S106), holding, on the first holding sheet 210, the end portion 1b on the first end surface, on which the first external electrode 5A is formed, of each of the plurality of chips 1 held on the second holding sheet 220 (step S107), peeling off, from the second holding sheet 220, the end portion 2b on the second end surface of each of the plurality of chips 1 held on the second holding sheet 220 (step S108), and forming collectively the second external electrode 5B defining and functioning as the external electrode on the end portion 2b on the second end surface peeled off from the second holding sheet 220, of each of the plurality of chips 1 held on the first holding sheet 210 (step S109).

With such a configuration, it is possible to efficiently form the first external electrode 5A and the second external electrode 5B in the plurality of chips 1, and it is possible to reduce or prevent a reduction in the yield.

### Other Example Embodiments of Alignment Device

Next, as other example embodiments of the alignment device, second to eighth example embodiments will be described. In the drawings referred to in the description, the same components as those in the first example embodiment or components having similar functions are denoted by the same reference numerals, and the description thereof is omitted or simplified.

### Second Example Embodiment

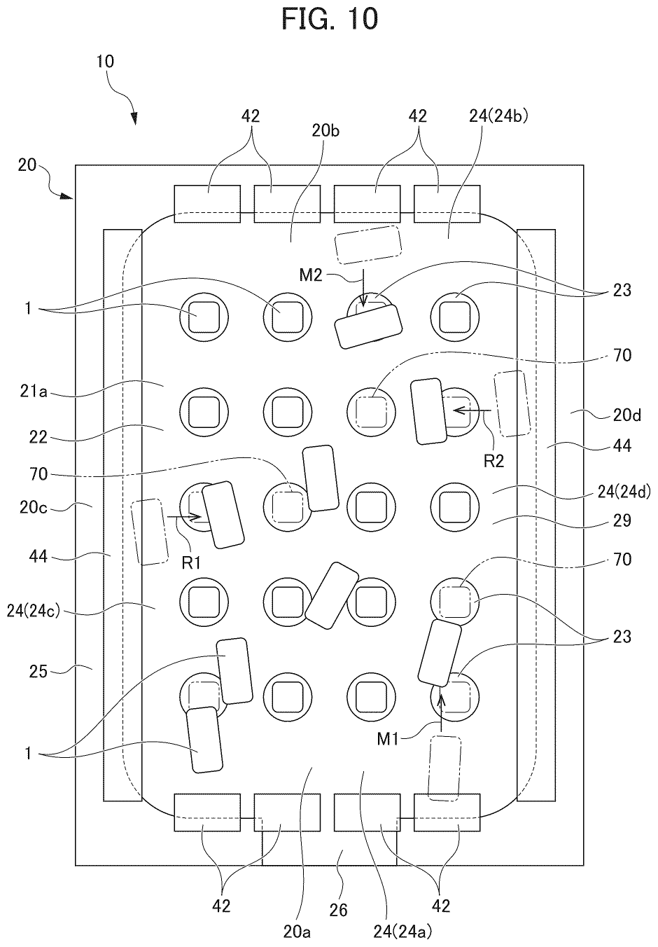

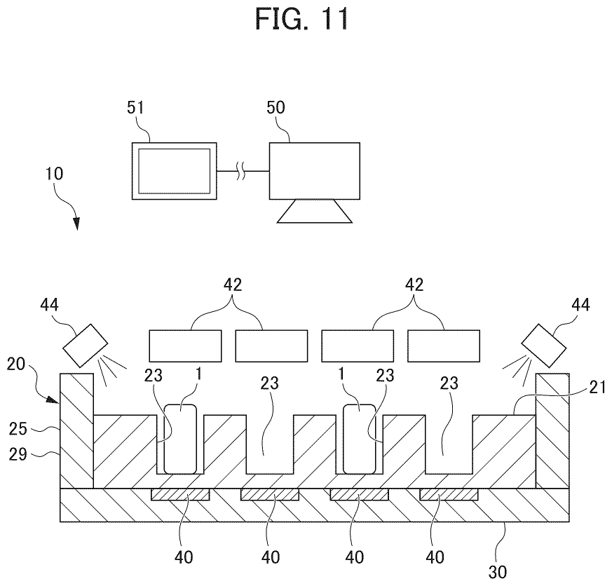

FIG. 10 is a plan view of an alignment device 10 according to the second example embodiment. FIG. 11 is a cross-sectional view of the alignment device 10 according to the second example embodiment. The alignment device 10 according to the second example embodiment includes a plurality of second magnets 42 and a plurality of air ejection portions 44 defining and functioning as movement assistance portions.

Some of the plurality of chips 1 supplied to the alignment area 22 may pass through the recessed portion 23, move to the surrounding surplus portion 24 and stay in the surplus portion 24. The plurality of second magnets 42 and the plurality of air ejection portions 44 each have a function of moving the chips 1 that have moved to the surplus portion 24 toward the recessed portions 23 supplementally to promote the accommodation of the chips 1 in the recessed portions 23.

For example, four second magnets 42 are respectively provided at the front-side end portion 20a and the rear-side end portion 20b of the pallet 20. These second magnets 42 are provided above the lateral wall portion 25 along the lateral wall portion 25. These second magnet 42 are preferably provided directly or in the vicinity of the lateral wall portion 25. The second magnets 42 are provided at positions corresponding to the recessed portions 23 arranged in the width direction (the left-right direction in FIG. 10) of the pallet 20. Each of the second magnets 42 is an electromagnet, and the magnetic pole is adjusted so that the magnetic pole repulsive to the chip 1 faces inward, i.e., toward the alignment area 22.

As shown in FIG. 10, when the chip 1 stays in a surplus portion 24a among the surplus portions 24 located adjacent to the front-side end portion 20a, the chip 1 can be moved to the inside of the alignment area 22 as indicated by an arrow M1 by the repulsive force of the magnetic force of the second magnet 42 positioned in the vicinity of the chip 1. In addition, when the chip 1 stays in a surplus portion 24b among the surplus portions 24 located adjacent to the rear-side end portion 20b, the chip 1 can be moved to the inside of the alignment area 22 as indicated by the arrow M2 by the repulsive force of the magnetic force of the second magnet 42 positioned in the vicinity of the chip 1. The chip 1 that has moved to the inside of the alignment area 22 is likely to be accommodated in the recessed portion 23.

One air ejection portion 44 is provided on both sides of the pallet 20, i.e., on each of a lateral portion 20c and a lateral portion 20d. Each air ejection portion 44 is provided above the lateral wall portion 25. Each of the air ejection portions 44 is preferably provided directly or in the vicinity of the lateral wall portion 25. Each of the air ejection portions 44 is a cylindrical member extending along the lateral wall portion 25, and compressed air is supplied to an inner space of the air ejection portion 44. The air ejection portion 44 includes a large number of ejection ports (not shown) to eject air toward the alignment area 22. The plurality of ejection ports are provided side by side from one end to the other end in the extending direction of the air ejection portion 44, for example.

As shown in FIG. 10, when the chip 1 stays in the surplus portion 24c adjacent to the lateral portion 20c, which is located on one side of surplus portions 24 (the left side in FIG. 10), the chip 1 can be moved to the inside of the alignment area 22 as indicated by an arrow R1 by being pressed by the flow of air ejected from the air ejection portion 44 located adjacent to the lateral portion 20c. Further, when the chip 1 stays in the surplus portion 24d adjacent to the lateral portion 20d, which is located on the other side of the surplus portion 24 (the right side in FIG. 10), the chip 1 can be moved to the inside of the alignment area 22 as indicated by an arrow R2 by being pressed by the flow of air ejected from the air ejection portion 44 located adjacent to the lateral portion 20d. The chips 1 that have moved to the inside of the alignment area 22 are likely to be accommodated in the recessed portions 23.

The alignment device 10 according to the second example embodiment includes the movement assistance portions that are provided in the lateral wall portion 25 or in the vicinity of the lateral wall portion 25 of the pallet 20 and move the chips 1 supplied to the alignment area 22 to the recessed portions 23 supplement ally.

Examples of the movement assistance portions include the second magnets 42 that move the chips 1 to the recessed portions 23 by the repulsive force of the magnetic force, and the air ejection portions 44 that move the chips 1 to the recessed portions 23 by ejected air.

This makes it possible to move the chip 1 remaining in the surplus portion 24 which is the peripheral portion of the alignment area 22 toward the recessed portion 23, thus further improving the filling rate.

The second magnets 42 and the air ejection portions 44 may be provided at any position. For example, the second magnets 42 and the air ejection portions 44 may be provided so as to be reversed from FIG. 10. Further, the plurality of second magnets 42 may be integrated. Alternatively, each of the air ejection portions 44 may be divided into a plurality of sections and provided side by side. Further, the movement assistance portions may only include the second magnets 42 that move the chips 1 toward the recessed portions 23 by repulsion of magnetic forces. Conversely, the movement assistance portions may only include the air ejection portions 44 that move the chips 1 toward the recessed portions 23 by ejected air. In other words, in FIG. 10, the plurality of second magnets 42 may be provided at the position of the air ejection portions 44 to configure the entire movement assistance portions by the second magnets 42, and conversely, the air ejection portions 44 may be provided at the position of the second magnets 42 to configure the entire movement assistance portions by the air ejection portions 44.

Next, third to fifth example embodiments in which the configuration of the first magnet 40 to attract and hold the chips 1 in the recessed portions 23 are modified will be described.

### Third Example Embodiment

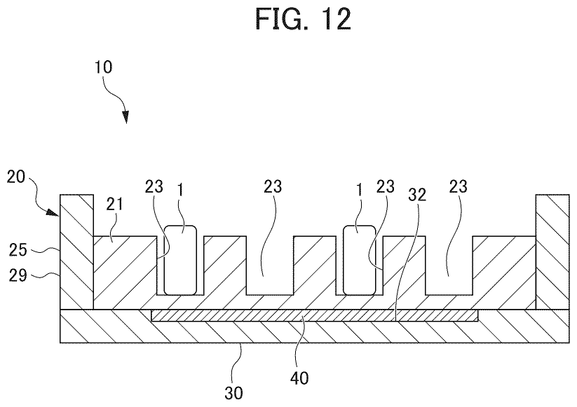

FIG. 12 is a cross-sectional view of the alignment device 10 according to the third example embodiment. In the third example embodiment, one first magnet 40 is provided, and the first magnet 40 has a size that covers all of the recessed portions 23 provided in the plurality of holding positions 70. The first magnet 40 is accommodated in one magnet accommodation portion 32 provided in the upper surface 30a of the base 30. The magnet accommodation portion 32 is a recess opened on the upper surface 30a of the base 30. The first magnet 40 is fitted into and accommodated in the magnet accommodation portion 32.

In the third example embodiment, the first magnet 40 has a size that covers all of the plurality of recessed portions 23.

With such a configuration, since only one first magnet 40 is required, it is possible to reduce the number of components and simplify the configuration.

The first magnet 40 may be a single magnet that covers all of the plurality of recessed portions 23. However, the first magnet 40 may cover all of the plurality of recessed portions 23 by a plurality of (e.g., two, four, eight, etc.) first magnets 40 having appropriate sizes. In this case, the first magnet 40 has a size that covers a plurality of recessed portions 23 as a portion of all the recessed portions 23.

### Fourth Example Embodiment

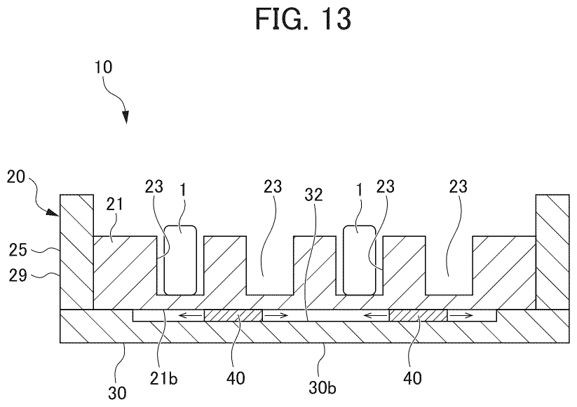

FIG. 13 is a cross-sectional view of the alignment device 10 according to the fourth example embodiment. In the fourth example embodiment, a magnet accommodation portion 32 similar to that in the third example embodiment is provided in the base 30. A plurality of first magnets 40 are movably provided in the magnet accommodation portion 32. The plurality of first magnets 40 are sandwiched between the pallet body 29 and the base 30, and are movable in a horizontal or substantially horizontal direction parallel or substantially parallel to the surface 21a while sliding. In this case, any number of the first magnets 40 can be provided. However, each of the first magnets 40 is appropriately set to be movable arbitrarily in the horizontal or substantially horizontal direction within the magnet accommodation portion 32.

Each of the first magnets 40 is driven by a drive unit (not shown) provided adjacent to the lower surface 30b of the base 30. As the drive unit, a magnet that attracts the first magnet 40, an appropriate actuator, or the like that can move the first magnet 40 is used. The plurality of first magnets 40 are provided adjacent to the rear surface 21b of the flat plate portion 21 to be movable along the rear surface 21b. By moving the first magnet 40, it is possible to guide the chips 1 to the recessed portion 23.

In a case where the imaging unit 50 and the monitor 51 are provided, it is possible to understand a state in which the chips 1 are accommodated in the recessed portions 23 while looking at the monitor 51, to move each of the first magnets 40 beneath the recessed portions 23 in which the chips 1 are not accommodated, and to guide and accommodate each of the chips 1 in the recessed portion 23.

In the fourth example embodiment, each of the first magnets 40 is provided on the rear surface 21b of the flat plate portion 21 to be movable along the rear surface 21b, and guides the chips 1 to the recessed portions 23 by moving.

With such a configuration, it is possible to actively move the chips 1 to the recessed portions 23, and it is possible to align the chips 1 efficiently and quickly.

### Fifth Example Embodiment

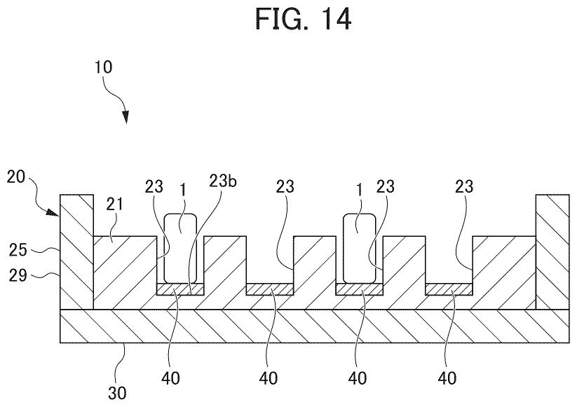

FIG. 14 is a cross-sectional view of the alignment device 10 according to the fifth example embodiment. In the fifth example embodiment, each of the first magnets 40 is provided adjacent to the surface 21a of the flat plate portion 21 of the pallet body 29 of the pallet 20 to correspond to a respective one of the plurality of recessed portions 23. The plurality of first magnets 40 are respectively inserted into the recessed portions 23 and provided on the bottom surface 23b.

In the fifth example embodiment, each of the plurality of first magnets 40 is provided on the surface 21a side of the flat plate portion 21 corresponding to each of the plurality of recessed portions 23.

According to the fifth example embodiment, since the first magnet 40 is provided adjacent to the surface 21a on which the chips 1 move, the magnetic force of the first magnets 40 that attracts the chips 1 directly acts on the chips 1, such that it is possible to accommodate the chips 1 in the recessed portions 23 more smoothly.

### Sixth Example Embodiment

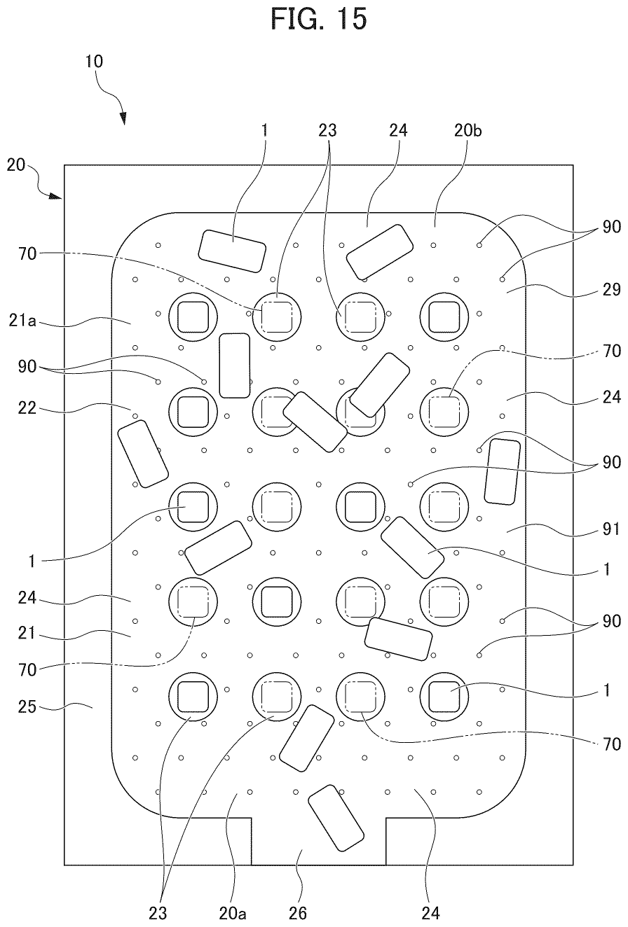

FIG. 15 shows a sixth example embodiment in which a large number of small holes 90 are provided on the surface 21a of the flat plate portion 21 of the pallet body 29 in the first example embodiment. The large number of small holes 90 are provided on the surface 21a except for each of the recessed portions 23. In this example embodiment, air is ejected from the large number of small holes 90 toward the surface 21a. For example, at least the surface 21a of the flat plate portion 21 of the pallet body 29 includes a porous plate 91, and compressed air is supplied to a sealed space provided on the rear side of the porous plate 91, such that air can be ejected from the large number of small holes 90 to the surface 21a.

The chips 1 supplied from the supply port 26 to the alignment area 22 move to slide on the surface 21a by the air ejected from the large number of small holes 90 to the surface 21a, and are attracted by the first magnets 40 during the movement and held in the recessed portion 23.

In the sixth example embodiment, at least the surface 21a of the alignment area 22 of the flat plate portion 21 includes the porous plate 91 in which the large number of small holes 90 are distributed, and air is ejected from the large number of small holes 90 to the surface 21a.

As a result, since the plurality of chips 1 move quickly in the alignment area 22, the time required for alignment can be shortened and, thus, it is possible to improve efficiency.

Next, the seventh example embodiment in which an air suction portion 60 is adopted instead of the first magnets 40 defining and functioning as a moving holder to attract/suction and hold the chips 1 in the recessed portions 23 will be described.

### Seventh Example Embodiment

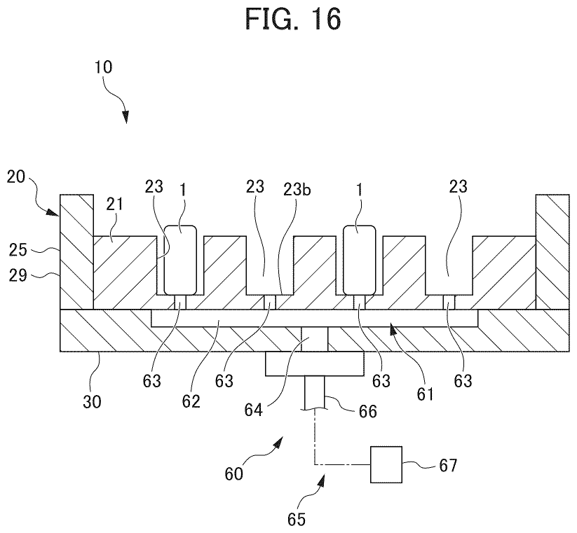

FIG. 16 is a cross-sectional view of an alignment device 10 according to the seventh example embodiment. The alignment device 10 of the seventh example embodiment includes an air suction portion 60 for sucking air in the recessed portions 23. The air suction portion 60 includes an intake flow path 61 provided in the pallet 20 and an intake mechanism 65.

The intake flow path 61 includes a main flow path 62 provided on the upper surface 30a of the base 30, a plurality of intake holes 63 branched from the main flow path 62 into the recessed portions 23, and an intake port 64 leading from the main flow path 62 to the lower surface 30b of the base 30. The main flow path 62 includes a recess provided in the upper surface 30a of the base 30. Each of the plurality of intake holes 63 extends from the bottom surface 23b of each of the recessed portions 23 to the lower surface 30b of the pallet body 29, and communicates with the main flow path 62. The intake port 64 is provided in the middle of the base 30, and communicates with the main flow path 62. The intake mechanism 65 includes an intake pipe 66 connected to the base 30 and communicating with the intake port 64, and an air suction source 67 such as a vacuum pump connected to the intake pipe 66.

According to the air suction portion 60, when the air suction source 67 is operated, air in each of the recessed portions 23 is sucked through the intake pipe 66, the intake port 64, the main flow path 62, and the intake hole 63. With such a configuration, the chips 1 are suctioned and accommodated in the recessed portions 23.

In the seventh example embodiment, the moving holder is the air suction portion 60 that suctions and holds the chips 1 in the recessed portions 23 by sucking air in the recessed portions 23 on the holding position 70.

With such a configuration, it is possible to accurately hold the plurality of chips 1 in the respective recessed portions 23 of the plurality of holding positions 70 set in advance. Since air in each of the recessed portions 23 is sucked so that each of the chips 1 is adsorbed on the bottom surface 23b, even if the pallet 20 vibrates, it is possible to reduce or prevent a situation in which the chips 1 jump out from the recessed portions 23. Therefore, since the chips 1 are filled and held in all of the plurality of recessed portions 23, it is possible to obtain a sufficient filling rate. Further, since the chips 1 are held in the recessed portions 23 by suction of air, even if the chips 1 do not have magnetic property, it is still possible to reliably hold and align such chips 1 in the recessed portions 23.

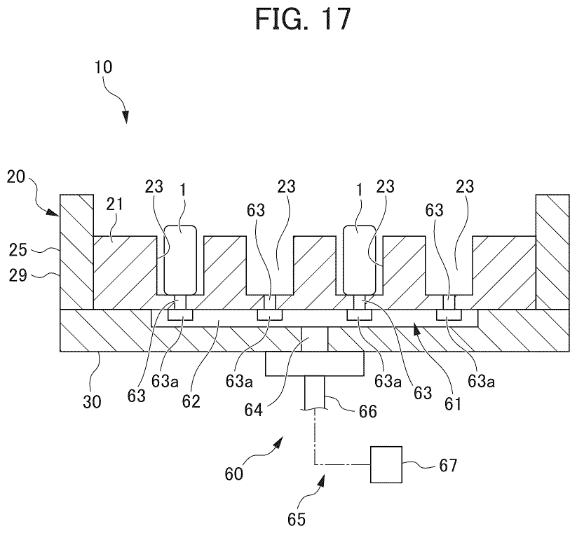

In the seventh example embodiment, as shown in FIG. 17, it is also possible to provide a valve 63a that opens and closes each of the intake holes 63 for each of the intake holes 63. When each of the valves 63a is closed, air in the recessed portion 23 is not sucked. In a case where the imaging unit 50 and the monitor 51 are provided, it is possible to understand a state in which the chips 1 are accommodated in the recessed portions 23 while looking at the monitor 51, to open the valve 63a corresponding to each of the recessed portions 23 in which the chip 1 is not accommodated to enable suction of the chip 1, and to close the valve 63a corresponding to each of the recessed portions 23 when the chip 1 is accommodated therein.

Next, the eighth example embodiment in which the surface 21a of the pallet body 29 does not include the plurality of recessed portions 23 to accommodate the chips 1, and the entire surface of the surface 21a is flat will be described.

### Eighth Example Embodiment

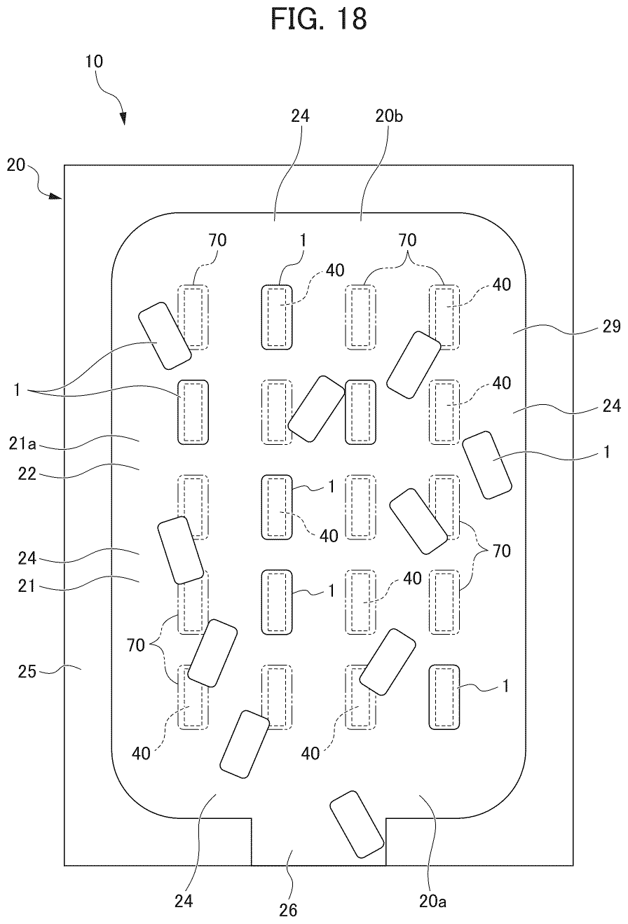

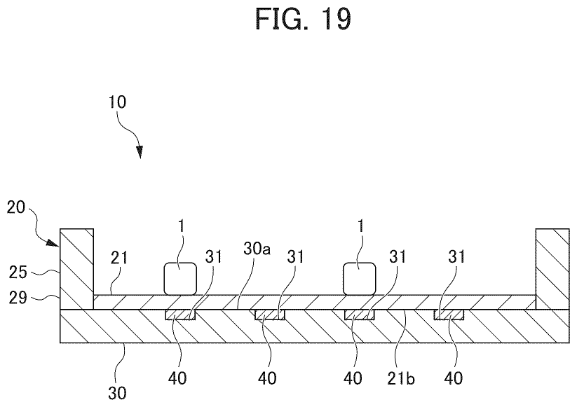

FIG. 18 is a plan view of an alignment device 10 according to the eighth example embodiment. FIG. 19 is a cross-sectional view of the alignment device 10 according to the eighth example embodiment. In the eighth example embodiment, the entire surface 21a of the pallet body 29 of the alignment area 22 is flat or substantially flat. In the alignment area 22, a plurality of holding positions 70 are set which function as positions to hold and align the plurality of chips 1. In the present example embodiment, similarly to the plurality of recessed portions 23 of the first example embodiment, twenty of the holding positions 70 are evenly provided in a matrix of 4 rows×5 columns, for example. Each of the holding positions 70 is a rectangular or substantially rectangular portion corresponding to the shape of the chip 1 in a plan view. However, example embodiments of the present invention is not limited to such a shape.

As shown in FIG. 19, first magnets 40 are provided immediately below the plurality of holding positions 70 and on the rear surface 21b of the flat plate portion 21. Each of the plurality of first magnets 40 is fitted and accommodated in a magnet accommodation portion 31 provided on the upper surface 30a of the base 30.

According to the eighth example embodiment, the plurality of chips 1 supplied from the supply port 26 to the alignment area 22 are stopped and held at the respective holding positions 70 by the attraction force of the first magnets 40 during the movement toward the rear-side end portion 20b, and are aligned. Since the chips 1 are easy to move in a horizontal posture in which the main surface 1c or the lateral surface 1d comes into contact with the surface 21a, the chips 1 are held at the respective holding position 70 in a horizontal posture.

In a case of holding the chips 1 at the respective holding positions 70 in their horizontal postures, when the external electrodes are formed at both ends in the length direction of each of the chips 1 as shown in FIGS. 9A to 9I, for example, the external electrodes can be formed by rolling each of the chips 1 to convert the posture into the vertical posture.

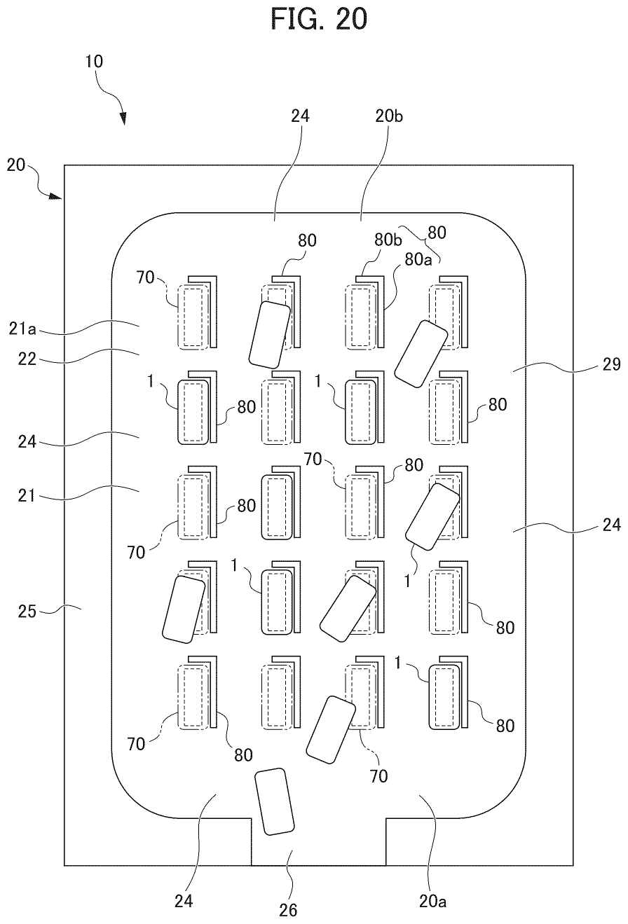

FIG. 20 shows a modified example of the eighth example embodiment. When the surface 21a of the alignment area 22 is flat, as shown in FIG. 20, it is preferable to provide a stopper portion 80 to stop the chip 1 at each holding position 70. The stopper portion 80 is an L-shaped member in a plan view including a lengthwise portion 80a along one long side of the rectangular holding position 70 and a crosswise portion 80b along the short side of the rear-side end portion 20b. The height of the stopper portion 80 is a height at which the vibrating chip 1 can be stopped, for example. When the chip 1 that has moved to the holding position 70 is locked by the stopper portion 80, further movement of the chip 1 toward the rear-side end portion 20b is restricted, and the chip 1 is stopped and held at the holding position 70.

In the eighth example embodiment, it is preferable to include the stopper portion 80 that stops the chip 1 having moved to the holding position 70 at the holding position 70.

With such a configuration, even when the surface 21a of the alignment area 22 is flat, it is possible to stop and hold the chip 1 at the holding position 70, and it is possible to ensure the alignment state.

In the eighth example embodiment described above, the air suction portion 60 of the seventh example embodiment may be applied instead of the first magnet 40 as a moving holder for suctioning/attracting and holding the chip 1. Further, in the above-described third to eighth example embodiments, the second magnet 42 and the air ejection portion 44 defining and functioning as the movement assistance portion shown in the second example embodiment may be combined.

Although example embodiments have been described above, the present invention is not limited to these example embodiments, and modifications, improvements, combinations, and the like, are encompassed by the present invention.

For example, the first magnet 40 that attracts and holds the chip 1 may be a permanent magnet. In such a case, the magnetic force cannot be turned ON/OFF like an electromagnet. However, such a permanent magnet still can be used so long as the function of attracting the chip 1 is sufficient. Although the second magnet 42 and the air ejection portion 44 are described as the movement assistance portion to move the chips 1 remaining in the surplus portion 24 of the alignment area 22 toward the holding position 70 supplementally, these are merely examples, and any configurations may be used as long as they have such functions. In the example embodiments, the chip, which is the laminate body before an external electrode is formed in a multilayer ceramic capacitor, is an example of a workpiece. However, such a workpiece is not limited thereto, and other chip-shaped electronic components such as a multilayer ceramic capacitor and a semiconductor device serving as products, can also be applied as the workpiece.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An alignment device comprising:
a pallet including a flat plate portion including a surface and a rear surface, and a lateral wall portion that extends from the surface of the flat plate portion and includes an alignment area to which a plurality of workpieces are supplied, the pallet being configured to be vibrated;
a plurality of holding positions in the alignment area each to hold a corresponding one of the plurality of workpieces in an alignment state;
a supply port including a portion of the lateral wall portion of the pallet and being open to allow the plurality of workpieces to be supplied into the alignment area from outside of the lateral wall portion; and
a moving holder provided in the flat plate portion to cause each of the plurality of workpieces supplied from the supply port to the alignment area to move to a corresponding one of the plurality of holding positions, and hold each of the plurality of workpieces at a corresponding one of the plurality of holding positions.

2. The alignment device according to claim 1, further comprising a recessed portion to accommodate a workpiece at each of the plurality of holding positions.

3. The alignment device according to claim 1, wherein the moving holder includes a first magnet to move a workpiece to one of the holding positions by magnetic attractive force and hold the workpiece at the holding position.

4. The alignment device according to claim 3, wherein the first magnet includes a plurality of first magnets provided on the rear surface to respectively correspond to the plurality of holding positions.

5. The alignment device according to claim 3, wherein the first magnet covers a portion or all of the plurality of holding positions.

6. The alignment device according to claim 3, wherein the first magnet is movably provided on the rear surface of the flat plate portion along the rear surface to guide the workpiece to one of the holding positions by moving.

7. The alignment device according to claim 3, wherein the first magnet includes a plurality of first magnets provided on the surface of the flat plate portion to respectively correspond to the plurality of holding positions.

8. The alignment device according to claim 1, wherein the moving holder includes an air suction portion to suction one of the workpieces and hold the one of the workpieces at a corresponding one of the holding positions by suctioning air above the holding position.

9. The alignment device according to claim 1, further comprising a stopper portion to stop the workpiece that has moved to the holding position at the holding position.

10. The alignment device according to claim 1, further comprising a movement assistance portion that is provided in the lateral wall portion or in a vicinity of the lateral wall portion to supplementally move the workpiece supplied to the alignment area to one of the holding positions.

11. The alignment device according to claim 10, wherein the movement assistance portion includes a second magnet to move the workpiece to the holding position by magnetic repulsive force.

12. The alignment device according to claim 10, wherein the movement assistance portion includes an air ejection portion to move the workpiece to the holding position by ejecting air.

13. The alignment device according to claim 1, wherein at least the surface of the alignment area of the flat plate portion includes a porous plate including holes to eject air toward the surface.

14. The alignment device according to claim 1, further comprising:
a feeder that is connected to the supply port to convey workpieces to the alignment area of the pallet by vibrating; wherein
vibration of the feeder is transmitted to the pallet so that vibration is commonly supplied to the feeder and the pallet.

15. A method of forming an external electrode on each of an end portion on a first end surface and an end portion on a second end surface included in each of a plurality of workpieces using an alignment device according to claim 1, the method comprising:
imparting vibration to a pallet;
supplying a plurality of workpieces from a supply port to an alignment area;
moving via a moving holder each of the plurality of workpieces supplied to the alignment area to a corresponding one of a plurality of holding positions, holding the end portion on the first end surface of each of the plurality of workpieces at a corresponding one of the plurality of holding positions, and holding the end portion on the second end surface in a state of being separated from a surface of the pallet;
holding collectively the end portion on the second end surface of the plurality of workpieces respectively held at the plurality of holding positions on the second holding sheet;
separating collectively the plurality of workpieces held on the second holding sheet from the respective holding positions;
forming collectively a first external electrode on the end portion on the first end surface of each of the plurality of workpieces held on the second holding sheet;
holding, on a first holding sheet, the end portion on the first end surface, on which the first external electrode is formed, of each of the plurality of workpieces held on the second holding sheet;
peeling off, from the second holding sheet, the end portion on the second end surface of each of the plurality of workpieces held on the second holding sheet; and
forming collectively a second external electrode, on the end portion on the second end surface peeled off from the second holding sheet, of each of the plurality of workpieces held on the first holding sheet.

16. The method according to claim 15, wherein the moving is performed using magnetic attraction, magnetic repulsion, or air.

17. The method according to claim 15, wherein the moving holder includes a first magnet to move a workpiece to one of the holding positions by magnetic attractive force and hold the workpiece at the holding position.

18. The method according to claim 17, wherein the first magnet includes a plurality of first magnets provided on the rear surface to respectively correspond to the plurality of holding positions.

19. The method according to claim 17, wherein the first magnet is movably provided on the rear surface of the flat plate portion along the rear surface to guide the workpiece to one of the holding positions by moving.

20. The method according to claim 15, wherein the moving holder includes an air suction portion to suction one of the workpieces and hold the one of the workpieces at a corresponding one of the holding positions by suctioning air above the holding position.
